(19) United States
(12) Patent Application Publication
(10) Pub. No.: US 2009/0253455 A1
(43) Pub. Date: Oct. 8, 2009

(54) METHOD FOR AUTOMATICALLY SWITCHING OPERATION PROFILES ON A MOBILE DEVICE AND SYSTEM THEREOF

(76) Inventor: Jing-Kuang Huang, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/099,105

(22) Filed: Apr. 7, 2008

(51) Int. Cl. H04M 1/00

(52) U.S. Cl. 455/550.1

(57) ABSTRACT

A method for automatically switching operation profiles on a mobile device includes storing an operation profile database having a plurality of operation profiles; mapping a velocity range to each operation profile to thereby form a velocity and profile table; monitoring a velocity of the mobile device; and switching between the operation profiles of the mobile device according to the velocity of the mobile device, and the velocity and profile table.

### BACKGROUND OF THE INVENTION

1. Field of the Invention

The present invention relates to a method for automatically switching operation profiles on a mobile device and system thereof, and more particularly, a method for automatically switching operation profiles on a mobile device according to the velocity of the mobile device and a velocity and operation profile table, and a related mobile device.

2. Description of the Prior Art

Mobile devices such as mobile phones are becoming increasingly popular in urban society. We take them with us wherever we go: the office, home, to the beach, on airplanes, to the movies. Each of these environments requires care to be taken based on proper modern etiquette as well as government and safety regulations. For example, it is considered common courtesy to lower the ring/sound volume on your mobile/portable device when in a quiet setting such as the office, and to shut it off or set it “on vibrate” when in a movie theatre. In moving vehicles, other rules should also be adhered to: it is forbidden by many federal and international regulations to operate a mobile wireless device while in an airplane, and many states in the USA have varying laws restricting or prohibiting the use of mobile phones while driving.

Most, if not all, mobile device manufacturers have addressed the various situations by allowing users to have multiple operating profiles (commonly called “profiles”) on the mobile phone (for example), each profile having different settings: ring volume, selected ring tone, vibrate on/off, keypad tones, display brightness, etc. Mobile phone users manually set the profile to use, according to their immediate environments and/or their preferences at the time. It is, however, rather easy (and common) for users to forget to switch profiles—particularly from a louder profile to a softer one—much to the chagrin of those around him/her. In circumstances where the turning off of mobile devices is in compliance with regulations, forgetting to switch to that profile could result in prosecution and disciplinary action.

As such, there is a need to provide a manner by which the user needn't manually switch profiles, be it for courtesy or safety reasons.

### SUMMARY OF THE INVENTION

It is therefore an objective of the present invention to solve the aforementioned problems, and to provide a method for automatically switching operation profiles on a mobile device, the method comprising storing an operation profile database having a plurality of operation profiles, mapping a velocity range to each operation profile to thereby form a velocity and profile table, monitoring a velocity of the mobile device and switching between the operation profiles of the mobile device according to the velocity of the mobile device, and the velocity and profile table. Such a method alleviates the user from manually switching operating profiles, avoiding unnecessary (and often unintentional) discourtesy and/or law-breaking, as well as mitigating safety risks.

These and other problems are generally solved or circumvented, and technical advantages are generally achieved, by advantageous embodiments of the present invention, which includes a method as above, further comprising storing a current operation profile as a previous operation profile of the mobile device when switching to a new operation profile, and returning to the previous operation profile when the velocity of the mobile device is within the velocity range of the previous operation profile.

In another embodiment, a method further comprises notifying a user when switching between operation profiles of the mobile device. One embodiment further comprises switching between the operation profiles of the mobile device further according to a user confirmation, wherein switching between the operation profiles of the mobile device can be rejected by the user.

An embodiment further comprises switching between the operation profiles of the mobile device further according to the historical user preferences. Another comprises switching to a target operation profile when the velocity of the mobile device is within the velocity range of the target operation profile.

An extension of the above embodiments further comprises mapping an entering velocity range and an exiting velocity range to each operation profile in the velocity and profile table, and switching to a target operation profile when the velocity of the mobile device is within the entering velocity range of the target operation profile and is outside of the exiting velocity range of a current operation profile, wherein the entering velocity range is different from the exiting velocity range.

Another method according to the present invention further comprises ranking a priority order of the operation profiles, determining at least one candidate operation profile for which the velocity of the mobile device is within the velocity range of the candidate operation profile, and switching to a target operation profile being a candidate operation profile having a highest priority. As an option, the priority order can be determined in order of descending velocity range.

The present invention, in one embodiment, is a mobile device for automatically switching operation profiles, comprising an operation profile database having a plurality of operation profiles, a velocity and profile table formed by mapping a velocity range to each operation profile, a velocity monitoring module for monitoring a velocity of the mobile device, and an operation profile switching module for switching between the operation profiles of the mobile device according to the velocity of the mobile device, and the velocity and profile table.

In one embodiment, the operation profile switching module from above is further for storing a current operation profile as a previous operation profile of the mobile device when switching to a new operation profile, and for returning to the previous operation profile when the velocity of the mobile device is within the velocity range of the previous operation profile. In another embodiment, the operation profile switching module of the mobile device is further for switching to a target operation profile when the velocity of the mobile device is within the velocity range of the target operation profile. Alternatively, the velocity and profile table is further for mapping an entering velocity range and an exiting velocity range to each operation profile in the velocity and profile table, and the operation profile switching module is further for switching to a target operation profile when the velocity of the mobile device is within the entering velocity range of the target operation profile and is outside of the exiting velocity range of a current operation profile, and the entering velocity range is different from the exiting velocity range.

A mobile device of the present invention, like the related methods, can further provide for ranking a priority order of the operation profiles, determining at least one candidate operation profile for which the velocity of the mobile device is within the velocity range of the candidate operation profile, and switching to a target operation profile being a candidate operation profile having a highest priority. This priority order could be determined in order of descending velocity range.

The velocity monitoring module of the mobile device can utilize a Global Navigation Satellite System (GNSS) device, such as a Global Positioning System (GPS) device.

The foregoing has outlined rather broadly the features and technical advantages of the present invention in order that the detailed description of the invention that follows may be better understood.

Additional features and descriptions of the present invention will be described hereinafter which form the subject of the claims of the present invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a flowchart for automatically switching operation profiles on a mobile device according to an embodiment of the present invention.

FIG. 2 is a diagram of example velocity ranges and operation profiles.

FIG. 3 is a state diagram for an embodiment of the present invention.

FIG. 4 shows a method according to an embodiment of the present invention, suggesting an interaction between a mobile device and a geographic information system (GIS) module or device.

FIG. 5 illustrates a method according to another embodiment of the present invention.

FIG. 6 is a method for monitoring the velocity of the mobile device, according to another embodiment of the present invention.

FIG. 7 shows an exemplary priority ranking according to one embodiment of the present invention.

FIG. 8 is a block diagram of a mobile device according to one embodiment of the present invention.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” The terms “couple” and “couples” are intended to mean either an indirect or a direct electrical connection. Thus, if a first device couples to a second device, that connection may be through a direct electrical connection, or through an indirect electrical connection via other devices and connections.

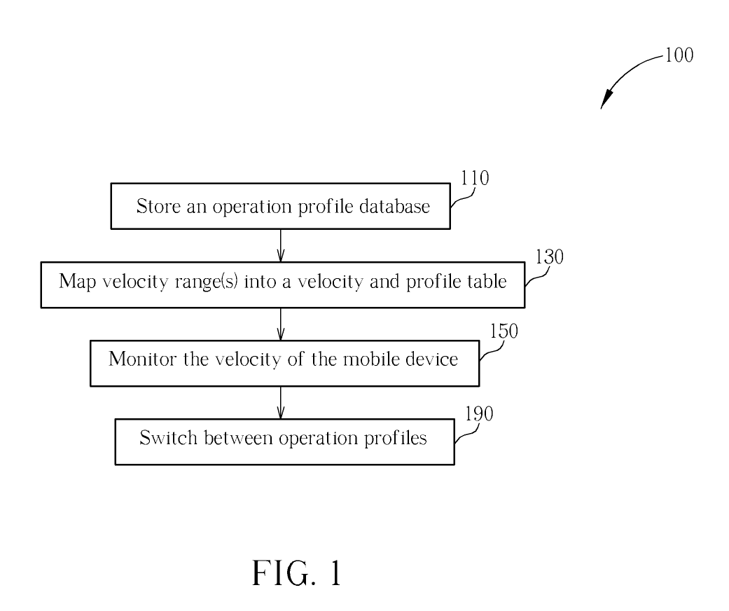

As mentioned, there is a need to provide a method for automatically switching operation profiles on a mobile device. FIG. 1 shows a flowchart 100 for automatically switching operation profiles on a mobile device according to an embodiment of the present invention. Provided that substantially the same result is achieved, the steps of the process flowchart need not be in the exact order shown and need not be contiguous; that is, other steps can be intermediate. The embodiment of the method according to the present invention includes the following steps:
Step 110: Store an operation profile database.
Step 130: Map a velocity range to each operation profile into a velocity and profile table.
Step 150: Monitor the velocity of the mobile device.
Step 190: Switch between the operation profiles of the mobile device according to the velocity of the mobile device.

As shown in FIG. 1, the flowchart 100 begins with Step 110 storing an operation profile database having a plurality of operation profiles. These operation profiles can be similar to what is currently found in mobile phones: a “meeting” profile, an “airplane” mode, etc. After a number of profiles has been defined and stored, Step 130 proceeds with mapping a velocity range to each operation profile to form a velocity and profile table. From the velocity and profile table, one can map from a velocity range to a corresponding profile and/or vice versa. After the operation profile database and the velocity and profile table have been configured, Step 150 monitors the velocity of the mobile device; this can be done on a continuous basis or sporadically (e.g., once every X seconds or Y minutes, based on design requirements). For Step 150, although monitoring the velocity could be achieved through the use of an accelerometer or similar sensor, a preferred implementation of this method would utilize a Global Navigation Satellite System (GNSS) device, including popular Global Positioning System (GPS) technologies.

According to the velocity of the mobile device and the velocity and profile table, the method switches between the operation profiles of the mobile device (Step 190). More specifically, a preferred clarification for Step 190 is where the method switches to a target operation profile when the velocity of the mobile device is within the velocity range of that target operation profile. For instance, when an operation profile called “Car” has been defined, and a velocity range of between 10 kmph and 150 kmph has been mapped to the “Car” profile, Step 190 switches the mobile device's operation profile to “Car” when the velocity of the mobile device is determined to be within the 10-150 kmph range.

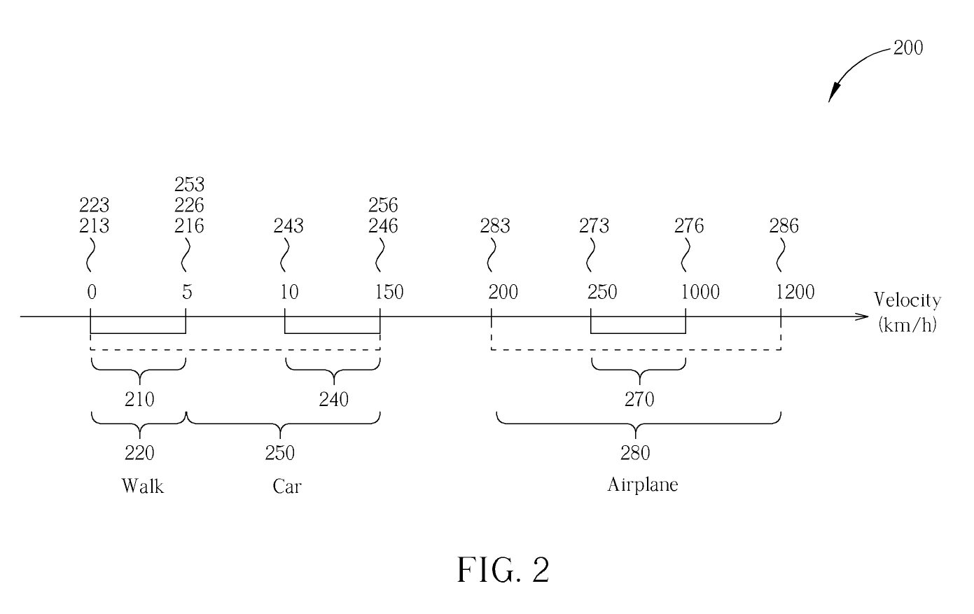

An extension of the above method, the method can further map an entering velocity range and an exiting velocity range to each operation profile in the velocity and profile table, where the entering and exiting velocity ranges can be different. Then, the method switches to a target operation profile when the velocity of the mobile device is within the entering velocity range of the target operation profile and is outside of the exiting velocity range of a current operation profile. As an example, please refer to FIG. 2 for a diagram of example velocity ranges and operation profiles. The diagram 200 of FIG. 2 shows three different operation profiles—“Walk”, “Car”, and “Airplane”—each with associated entering and exiting velocity ranges. The “Walk” operation profile has an entering velocity range 210 comprising a lower bound 213 (at 0 kmph) and an upper bound 216 (at 5 kmph), and an exiting velocity range 220 comprising a lower bound 223 (at 0 kmph) and an upper bound 226 (at 5 kmph). Similarly, the “Car” operation profile has an entering velocity range 240 comprising a lower bound 243 (10 kmph) and an upper bound 246 (150 kmph), and an exiting velocity range 250 comprising a lower bound 253 (5 kmph) and an upper bound 256 (150 kmph). A third exemplary operation profile, “Airplane”, has an entering velocity range 270 comprising a lower bound 273 (250 kmph) and an upper bound 276 (1000 kmph), and an exiting velocity range 280 comprising a lower bound 283 (200 kmph) and an upper bound 286 (1200 kmph).

Based on the example shown in FIG. 2, when the mobile device implementing the method embodiment described above moves from Okmph to 25 kmph, the method switches the mobile device to the “Car” operation profile, because it is within the 10-150 kmph entering velocity range 240 of the “Car” profile. While continuing to monitor its velocity, the mobile device remains in the “Car” profile even as the velocity dips below 10 kmph to 7 kmph. The method will only exit the “Car” profile when the velocity of the mobile device is below 5 kmph or above 150 kmph. Following this case, when the velocity drops to 5 kmph, the method will switch from “Car” profile to “Walk” profile, because the entering velocity range 210 of “Walk” covers the 0-5 kmph span. In the example of the “Walk” profile, the exiting velocity range 220 is also 0-5 kmph, and leaving this range will cause the method to exit the “Walk” operation profile. The “Airplane” profile operates in a similar way, according to this embodiment of the present invention, so further description is omitted.

One notes that the above examples show exiting velocity ranges being the same or “wider” than the entering velocity ranges; this is not a limitation of the present invention, since it is apparent that there is no restriction between the relativity of entering and exiting velocity ranges. Additionally, the entering and exiting velocity ranges of the “Walk” operation profile are the same; as is clear from above, this is also permitted and certainly within the scope of this invention. Not shown in FIG. 2 is a situation where entering and/or exiting velocity ranges of different operation profiles are overlapping: in such cases, the method should include the necessary logic and decision-making procedures to ensure smooth operation and operation profile switching, but a person of ordinary skill in the art should already understand this.

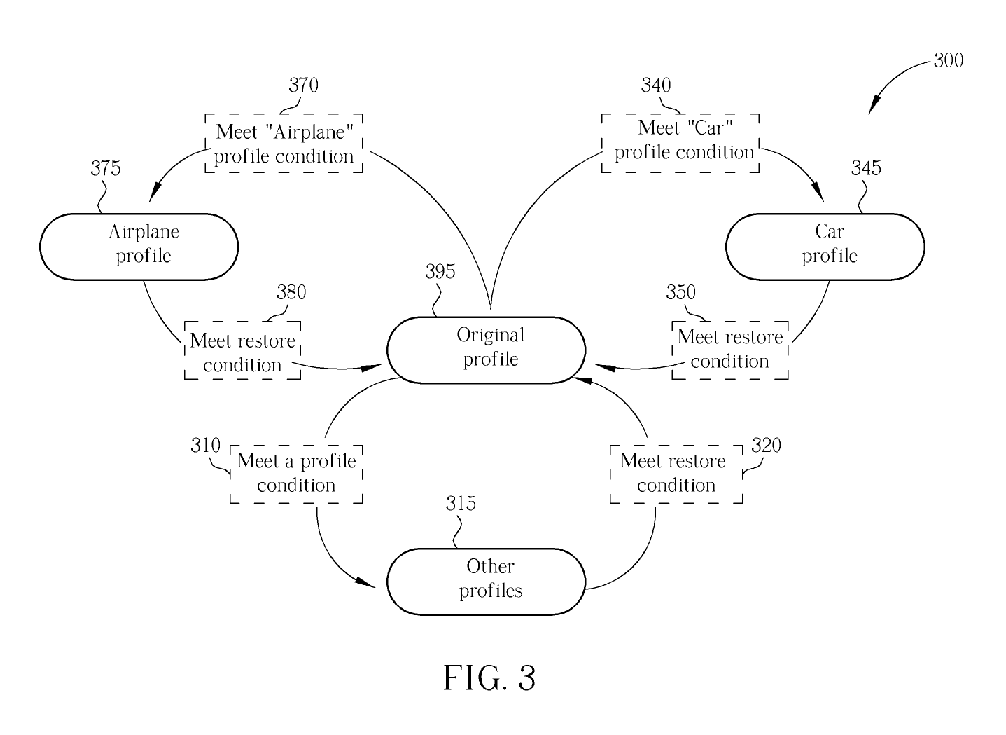

In a further enhancement to the above embodiments, the method can further comprise storing the current operation profile of the mobile device as a “previous operation profile” when switching to a new operation profile, and then when the velocity of the mobile device is within the velocity range of the previous operation profile again, returning to the previous operation profile. FIG. 3 is a state diagram for this embodiment of the present invention for assisting an explanation of this scenario. The diagram 300 shows an “Original” (or “Normal”) profile 395, an “Airplane” profile 375, a “Car” profile 345, and another profile 315 (which we may take as similar the “Walk” profile in FIG. 2, for the sake of simplicity). The profile condition 310 and the restore condition 320 for the profile 315 are substantially similar to the relationship between the entering velocity range 210 and the exiting velocity range 220 for the “Walk” profile (FIG. 2). By the same token, one can draw parallels between the “Car” profile 345 and the “Car” profile in FIG. 2, with the profile condition 340 and restore condition 350 being similar to the entering and exiting velocity ranges 240 and 250, respectively. FIG. 3 shows, then, when profile conditions for a certain operation profile are satisfied, the mobile device is switched to that profile; when the restore conditions are met—said another way, when the profile conditions for another profile are met—the mobile device is returned to the stored “previous operation profile”. Though not explicitly shown in FIG. 3, additional profile switching paths are also possible. The present invention includes embodiments wherein the mobile device can switch between different operation profiles (say, “Car” profile 345 and “Airplane” profile 375) without having to return to the “Original” profile 395, and such implementations will depend on specific design requirements and configurations.

It should also be noted here that the profile conditions (310, 340, 370) and restore conditions (320, 350, 380) shown in FIG. 3 can encompass other factors and requirements besides the respective entering and exiting velocity ranges previously described: additional method intelligence or processing can be implemented to provide smoother and more appropriate profile switching on the mobile device. Switching to a target operation profile of the mobile device can be according to a time duration of the mobile device being within a velocity range of the target operation profile: for instance, an optional requirement could be that the mobile device must be traveling at between 10 kmph and 150 kmph for at least 3 minutes before switching to the “Car” profile. In another embodiment, switching to a target operation profile of the mobile device is further according to statuses of other devices connected to the mobile device, such as the accessories currently in use with the mobile device. One example of this embodiment requires the mobile device to be traveling within the “Car” profile velocity range and to be connected either to a wired headset, car kit, or a Bluetooth™ enabled wireless headset. It becomes apparent that any number of different factors and requirements can be combined with the velocity monitoring in the mobile device to follow in the spirit of the present invention, and should be considered within its scope.

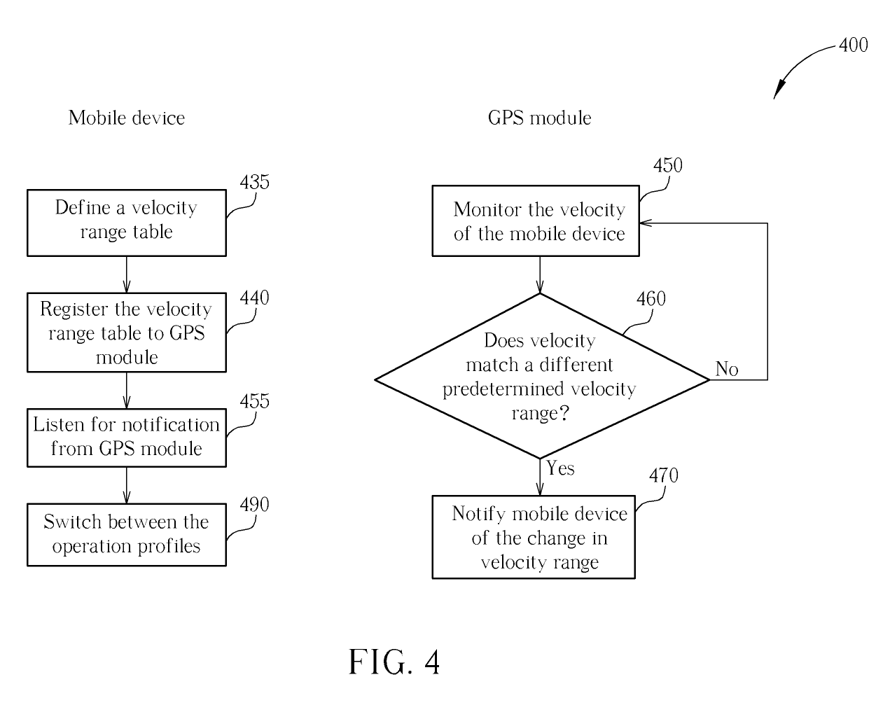

FIG. 4 shows a method according to an embodiment of the present invention, suggesting an interaction 400 between a mobile device and a geographic information system (GIS) module or device. The GIS module can be a Global Navigation Satellite System (GNSS) or Global Positioning System (GPS) module; in this case, we'll say it is a GPS module. The mobile device may include the GIS module within it, can be a separate device that is connected in some manner; for this example, we'll assume the mobile device has a GIS module inside it (so the velocity of the GIS module is substantially the same as that of the mobile device). The steps shown for the mobile device (left) portion of the interaction are:
Step 435: Define a velocity range table.
Step 440: Register the velocity range table to GPS module.
Step 455: Listen for notification from GPS module.
Step 490: Switch between the operation profiles of the mobile device according to the notifications from the GPS module.

The steps shown for the GPS module (right) portion of the interaction are:
Step 450: Monitor the velocity of the mobile device.
Step 460: When velocity matches any predetermined velocity ranges, proceed to Step 465; when not, return to Step 450.
Step 465: Notify mobile device of the change in velocity range.

Please note that the step numbers in FIG. 4 are ordered such that their chronological order is approximately according to their last two digits (e.g., Step 490 normally follows Step 465); numbers with last two digits corresponding to those from FIG. 1 are substantially similar (e.g., Steps 190 and 490).

The interaction flowchart 400 begins with Step 435, which defines a velocity range table in the mobile device. This can be done in a similar manner to Step 130 in FIG. 1, and could be a process allowing the user to configure the details. Next, Step 440 registers the velocity range table to the GPS module (the right side of the figure), and then the mobile device portion simply waits and listens for some notification from the GPS module (Step 455). Meanwhile, the GPS module commences monitoring the velocity of the mobile device in Step 450. Step 460 checks whether the velocity matches any predetermined velocity ranges. When there is a match to a different velocity range (than the current), the method proceeds to Step 465, where the mobile device is notified of the change in the velocity range; when not, it returns to Step 450. When a notification is received from the GPS module in Step 465, the mobile device undergoes Step 490 to switch between the operation profiles of the mobile device. In a normal scenario, the GPS module would continue to be monitoring the variation in its velocity, and notifies the mobile device at each time a change in the velocity range occurs.

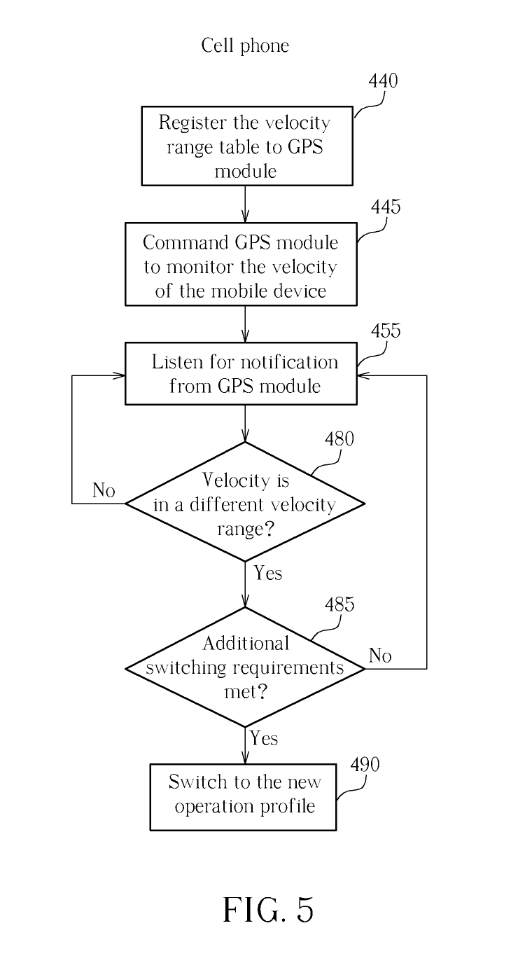

Please refer now to FIG. 5 for a method according to another embodiment of the present invention. As before, the step numbers in the flowchart figures are ordered such that their chronological order is approximately according to their last two digits; numbers with last two digits corresponding to those from FIGS. 1, 4 and 5 are substantially similar (e.g., Steps 190 and 490).
Step 440: Register the velocity range table to GPS module.
Step 445: Command GPS module to monitor the velocity of the mobile device.
Step 455: Listen for notification from GPS module.
Step 480: Velocity is in a different velocity range? If yes, proceed to Step 485; otherwise, return to Step 455.
Step 485: Additional switching requirements met? If yes, proceed to Step 490; otherwise, return to Step 455.
Step 490: Switch to the new operation profile of the mobile device.

Readers will notice that the flowchart of FIG. 5 is similar to that of FIG. 4, containing numerous overlaps; these overlaps will not be described again in detail. FIG. 5 further assumes the division of tasks between the mobile device and its GPS module, however, and digs further into the step details following a notification of a velocity change. In Step 445, after registering the velocity range table to the GPS module, the mobile device commands the GPS module to begin monitoring the velocity and then waits and listens for a notification (Step 455). When a notification is received from the GPS module (Step 470 of FIG. 4), a check is made to see whether the current velocity range is different from the previous one. When this is true, Step 485 is executed; otherwise, no profile changing need take place, and the flowchart returns to Step 455 to wait for another notification. In Step 485, additional switching requirements (if any) are checked to see if they are also met: when all requirements are satisfied, the method proceeds to Step 490 (switching to the new operation profile), or else the flowchart goes back to Step 455.

In Step 485, the additional switching requirements can be many, depending on specific configurations or implementation designs. For instance, the check could comprise something as simple as notifying the user when switching between operation profiles of the mobile device, and receiving user confirmation (to proceed) or receiving a rejection by the user (in which case, no profile switch is done). As mentioned prior, other additional requirements or factors can be to check the existence or connection of accessories, or extra logic on the recent behavior of the device (e.g., having not changed a profile in at least X minutes, or at most Y minutes). Another embodiment comprises a condition for switching between the operation profiles of the mobile device further according to the historical user preferences. Persons of ordinary skill in the art can surely develop other examples after reading this disclosure.

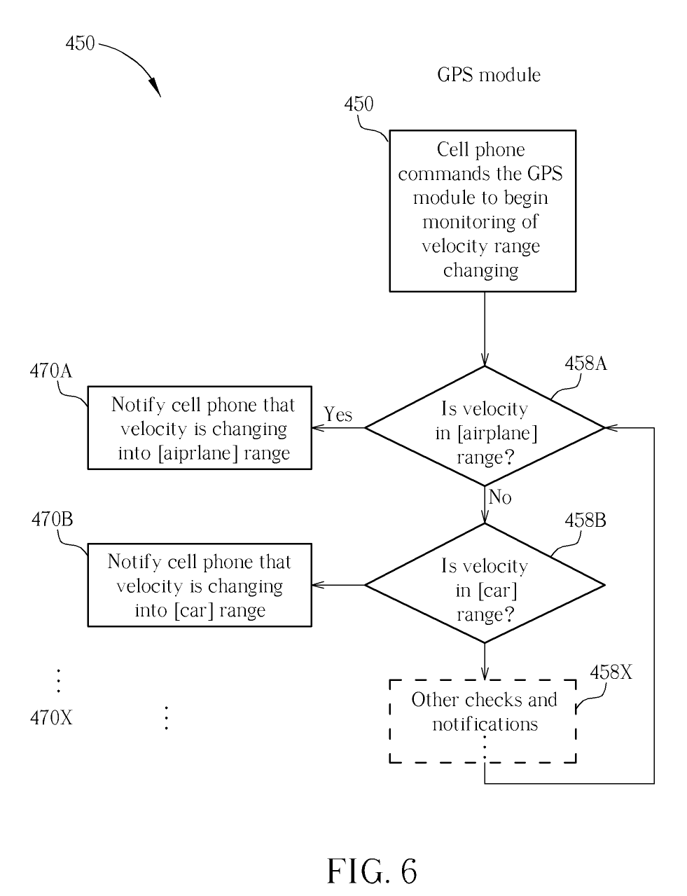

Please now refer to FIG. 6, a method for monitoring the velocity of the mobile device, according to another embodiment of the present invention. The method shown in FIG. 6 can be roughly seen as equivalent to Step 450, 460 and 470 shown in FIG. 4, the step of monitoring the velocity of the mobile device, as performed by the GPS module. Here, after being commanded by the mobile device to begin monitoring the velocity (Step 445 in FIG. 5), the GPS module proceeds to check the current velocity of the mobile device against a plurality of velocity ranges existing in the velocity range table (registered in Step 440 of FIG. 4). FIG. 6 gives an example of how this check could be implemented: the current velocity is sequentially checked against each velocity range in Steps 458A through 458X to determine which (if any) of the notification steps 470A through 470X should be done. When, in Step 458A (for example), the velocity is found to match the checked velocity range, then Step 470A is executed to notify the mobile device of the change in velocity range. When the check in Step 458A is false, however, the check proceeds to Step 458B to check the next velocity range, and so on. Clearly, this is not the only method by which a check against a series of velocity ranges can be implemented; other methods are also possible, and should be considered in the scope of this invention.

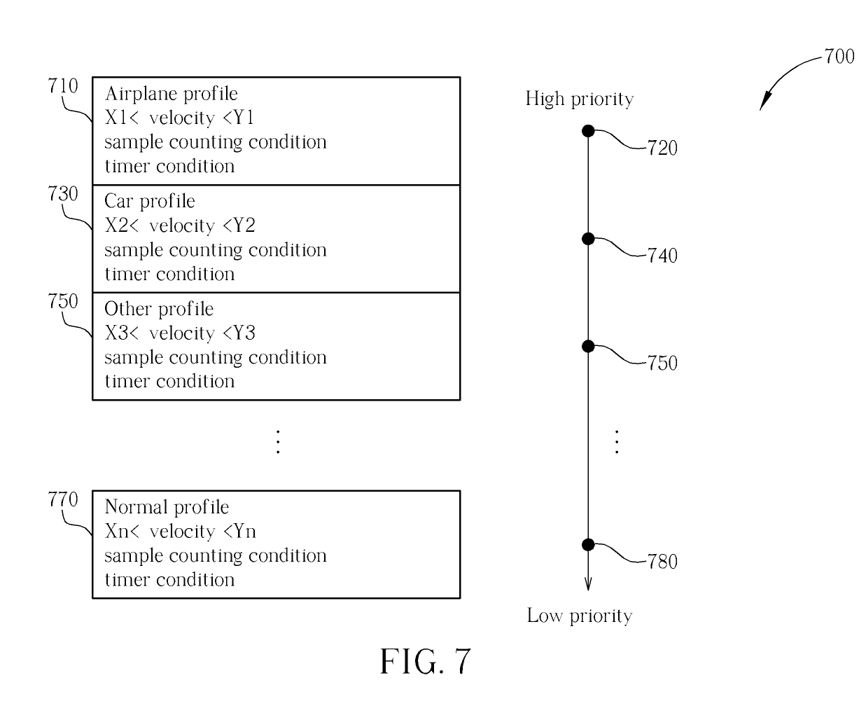

Delving further into Step 485, and related closely to Step 450 just discussed, another consideration is presented in FIG. 7, where the method adds onto those already disclosed by further ranking a priority order of the operation profiles in the mobile device. This additional method determines at least one candidate operation profile for which the velocity of the mobile device is within the velocity range of the candidate operation profile, and then switches to the one of those candidate profiles with the highest priority. The priority ranking used here can be arranged in numerous ways, and the priority diagram 700 of FIG. 7 shows an example where the priority order is determined in order of descending velocity range, from highest priority to lowest. In the diagram, the various profiles 710, 730, 750, . . . 770 are each associated with a priority ranking 720, 740, 760, . . . 780. In this particular example, the “Airplane” profile has a higher priority ranking than the “Car” profile, which in turn is higher than other profiles. Each of the profiles has also associated with it at least one velocity range, and other optional conditions (shown, but not marked) for entering and/or exiting the respective profiles; these features have already been explained in some detail above. Please note that the example shown in diagram 700 is arbitrary: any other number and/or arrangement of profiles are possible, and depend greatly upon specific implementations of the present invention.

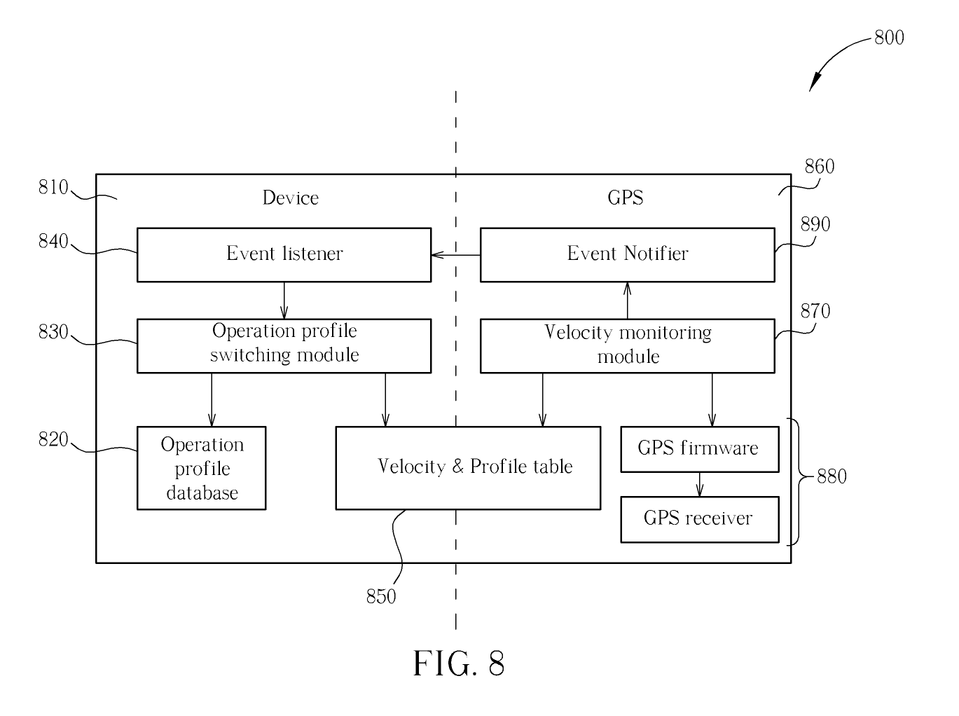

Now please turn your attention to FIG. 8, which is a block diagram of a mobile device according to one embodiment of the present invention. The mobile device 800 of FIG. 8 comprises two larger portions: the mobile device “portion” 810, and the GPS portion 860. Please keep in mind that the GPS portion 860 needn't be GPS; any functional GIS equivalent, such as a GNSS system, will suffice for the purposes of the present invention. Please note that although some descriptions of this mobile device in this example are well suited towards mobile phones, it is an arbitrary selection for illustration purposes only and is not intended as a limitation to the present invention.

The mobile device portion 810 comprises an operation profile database 820, an operation profile switching module 830, and an event listener 840. The GPS portion 860 comprises a velocity monitoring module 870, a GPS module 880 (which includes GPS firmware and a GPS receiver), and an event notifier 890. There is additionally a velocity and profile table 850 which may exist in either the mobile device portion 810 or the GPS portion 860, depending upon design and other requirements.

The operation profile database 820 has a plurality of operation profiles as described in the method embodiments above, whereas the velocity and profile table 850 maps a velocity range (or more, in the case of entering and exiting velocity ranges) to each operation profile in the operation profile database 820. The velocity monitoring module 870 is for monitoring the velocity of the mobile device and GPS module 880, since we are still assuming in this example that the two are portions of one device (though this may not be the case in other embodiments of the present invention). The results of the velocity monitoring module 870 are relayed through the event notifier 890 to the event listener 840 in the mobile device portion 810, which then invokes the operation profile switching module 830. The operation profile switching module 830 is for switching between the operation profiles of the mobile device 800 according to the velocity of the mobile device 800, and the velocity and profile table 850. Note that the operation profile switching module 830 will, in certain embodiments, perform additional logic based on the velocity of the mobile device 800 and other additional factors mentioned above.

Similar options and features as presented in the different embodiments in the method examples are also valid when considering the mobile device embodiment of the present invention. For instance, operation profile switching module 830 (in one implementation) will first store the current operation profile as a previous operation profile when switching to a new operation profile, and will return to this previous operation profile when the mentioned restore conditions are met again. The operation profile switching module 830 in another example will also notify the user when switching between profiles, which can optionally be rejected by the user. As a further option, operation profile switching module 830 can store both an entering velocity range and an exiting velocity range for each operation profile in the velocity and profile table 850; the operation profile switching module 830 then switches to a target profile when the velocity of the mobile device is within the entering velocity range of that target profile and is also outside of the exiting velocity range of the current operation profile. As before, the entering velocity range and the exiting velocity range in this case can be different from one another.

Previous given examples are also valid as embodiments with additional profile switching criteria for the operation profile switching module 830: priority ranking, historical user preferences, minimum or maximum time durations in a particular profile, and the like. Since the implementation for adding such logic is commonly known to those skilled in the art, further description is omitted.

Please note that although the current examples are shown utilizing a Global Navigation Satellite System (GNSS) or Global Positioning System (GPS) device, this is only intended for clarity of explanation and is not meant as a limitation to the present invention. It should also be noted that although the examples given in this disclosure lend themselves easily to the conception of a mobile phone enabled with GPS technology, the application to a mobile phone is not meant to be a limitation of the scope of this invention. The present invention can be applied to any mobile or portable device which is enabled with any type of GIS module inside, even ones where the geographic information is produced by indirectly measuring velocity (such as by triangulation from other data sources). Such applications and embodiments also obey the spirit of, and should be considered within, the scope of the present invention.

To drive this point home, although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Those skilled in the art will readily observe that numerous modifications and alterations of the device and method may be made while retaining the teachings of the invention.

What is claimed is:

1. A method for automatically switching operation profiles on a mobile device storing an operation profile database having a plurality of operation profiles, the method comprising:
mapping a velocity range to each operation profile to thereby form a velocity and profile table;
monitoring a velocity of the mobile device; and
switching between the operation profiles of the mobile device according to the velocity of the mobile device, and the velocity and profile table.

2. The method of claim 1, further comprising notifying a user when switching between operation profiles of the mobile device.

3. The method of claim 1, further comprising:
switching between the operation profiles of the mobile device further according to a user confirmation,
wherein switching between the operation profiles of the mobile device can be rejected by the user.

4. The method of claim 1, further comprising:
switching between the operation profiles of the mobile device further according to the historical user preferences.

5. The method of claim 1, further comprising:
switching to a target operation profile when the velocity of the mobile device is within the velocity range of the target operation profile.

6. The method of claim 1, further comprising:
mapping an entering velocity range and an exiting velocity range to each operation profile in the velocity and profile table; and
switching to a target operation profile when the velocity of the mobile device is within the entering velocity range of the target operation profile and is outside of the exiting velocity range of a current operation profile,
wherein the entering velocity range is different from the exiting velocity range.

7. The method of claim 1, further comprising:
ranking a priority order of the operation profiles;
determining at least one candidate operation profile for which the velocity of the mobile device is within the velocity range of the candidate operation profile; and
switching to a target operation profile being a candidate operation profile having a highest priority.

8. The method of claim 7, wherein the priority order is determined in order of descending velocity range.

9. The method of claim 1, further comprising:
switching to a target operation profile of the mobile device further according to a time duration of the mobile device being within a velocity range of the target operation profile.

10. The method of claim 1, further comprising:
switching to a target operation profile of the mobile device further according to statuses of other devices connected to the mobile device.

11. The method of claim 1, further comprising:
monitoring the velocity of the mobile device utilizing a Global Navigation Satellite System (GNSS) device.

12. A mobile device for automatically switching operation profiles, comprising:
an operation profile database having a plurality of operation profiles;
a velocity and profile table formed by mapping a velocity range to each operation profile;
a velocity monitoring module for monitoring a velocity of the mobile device; and
an operation profile switching module for switching between the operation profiles of the mobile device according to the velocity of the mobile device, and the velocity and profile table.

13. The mobile device of claim 12, wherein the operation profile switching module is further for notifying a user when switching between operation profiles of the mobile device.

14. The mobile device of claim 12, wherein the operation profile switching module is further for switching between the operation profiles of the mobile device further according to a user confirmation, and switching between the operation profiles of the mobile device can be rejected by the user.

15. The mobile device of claim 12, wherein the operation profile switching module is further for switching between the operation profiles of the mobile device further according to the historical user preferences.

16. The mobile device of claim 12, wherein the operation profile switching module is further for switching to a target operation profile when the velocity of the mobile device is within the velocity range of the target operation profile.

17. The mobile device of claim 12, wherein
the velocity and profile table is further for mapping an entering velocity range and an exiting velocity range to each operation profile in the velocity and profile table; and
the operation profile switching module is further for switching to a target operation profile when the velocity of the mobile device is within the entering velocity range of the target operation profile and is outside of the exiting velocity range of a current operation profile, and
the entering velocity range is different from the exiting velocity range.

18. The mobile device of claim 12, wherein the operation profile switching module is further for ranking a priority order of the operation profiles, determining at least one candidate operation profile for which the velocity of the mobile device is within the velocity range of the candidate operation profile, and switching to a target operation profile being a candidate operation profile having a highest priority.

19. The mobile device of claim 18, wherein the priority order is determined in order of descending velocity range.

20. The mobile device of claim 12, wherein the operation profile switching module is further for switching to a target operation profile of the mobile device further according to a time duration of the mobile device being within a velocity range of the target operation profile.

21. The mobile device of claim 12, wherein the operation profile switching module is further for switching to a target operation profile of the mobile device further according to statuses of other devices connected to the mobile device.

22. The mobile device of claim 12, wherein the velocity monitoring module utilizes a Global Navigation Satellite System (GNSS) device.
